(19) United States
(12) Patent Application Publication
(10) Pub. No.: US 2006/0282530 A1
(43) Pub. Date: Dec. 14, 2006

(54) METHODS AND APPARATUS FOR END-USER BASED SERVICE MONITORING

(76) Inventors: Stephen D. Klein, New York, NY (US); Adam Erlebacher, New York, NY (US)

Correspondence Address: DALY, CROWLEY, MOFFORD & DURKEE, LLP, SUITE 301A, 354A TURNPIKE STREET, CANTON, MA, 02021-2714, US

(21) Appl. No.: 11/424,077

(22) Filed: Jun. 14, 2006

Related U.S. Application Data
(60) Provisional application No. 60/690,240, filed on Jun. 14, 2005.

(51) Int. Cl. G06F 15/173

(52) U.S. Cl. 709/224

(57) ABSTRACT

Methods and apparatus to receive requests for support from an automated support system for a plurality of topics for at least one service, track the support requests for at least two of the plurality of topics, and determine trends in the tracked support requests to generate alarms. In one embodiment, the automated support system includes an automated agent.

### CROSS REFERENCE TO RELATED APPLICATIONS

The present application claims in the benefit of U.S. Provisional Patent Application No. 60/690,240, filed on Jun. 14, 2005, which is incorporated herein by reference.

### STATEMENT REGARDING FEDERALLY SPONSORED RESEARCH

Not Applicable.

### BACKGROUND OF THE INVENTION

As is known in the art, service providers generally monitor the performance of the systems and services they provide to their customers. In general, the service provided is monitored for outages and other problems. For example, a phone company monitors the status of the central office system and their equipment.

However, it may be difficult to monitor service performance from the end user perspective. For example, for an Internet Service Provider, it may be difficult to determine that end users are having significant E-mail difficulty. On site monitoring may indicate that all systems are functional even though end users are unable to use E-mail or other services.

### SUMMARY OF THE INVENTION

The present invention provides methods and apparatus that use the amount and type of information accessed by users using an automated support system, as well as historical information about the levels of access to support information to automatically monitor the performance of service provided to end users. It does so by identifying changing trends in the topics requested by users from the customer support system. In one embodiment, the service provider monitors user interaction with an automated service agent to determine anomalous, e.g., spikes, in certain service areas.

In one aspect of the invention, a method comprises receiving user requests for support from an automated agent of an automated support system for a plurality of topics for at least one service, tracking the support requests for at least two of the plurality of topics, and determining trends in the tracked support requests to generate an alarm.

The method can further include one or more of following features: the received requests are processed by the automated agent, generating a baseline for topic support requests, the services include one or more of E-mail, Internet access, telephone, utilities, premise security, insurance coverage, banking, and investments, generating alarms by an alarm engine, identifying a party associated with the alarm and transmitting the alarm to the party, determining the trend includes determining a percentage increase above a predetermined threshold, receiving the requests as instant messages that initiate a conversation with an automated service agent, updating a distribution of the support request by topic, and comparing the distribution to a baseline distribution.

In another aspect of the invention, a system comprises an automated support system to receive user requests for support for a plurality of topics for at least one service, a monitoring module coupled to the automated support system to track the support requests and determine trends, and an alarm module to generate an alarm based upon the trends for the topic requests.

The system can further include one or more of the following features: the automated support system includes an automated agent to carry on a conversation with a user, the automated agent communicates with the user via instant messaging, the monitoring module generates a baseline for the support requests, the alarm module identifies a party to receive the alarm based upon the topic that generated the alarm.

### BRIEF DESCRIPTION OF THE DRAWINGS

The invention will be more fully understood from the following detailed description taken in conjunction with the accompanying drawings, in which:

FIG. 1 is a schematic block diagram of a system having user-based service monitoring in accordance with the present invention;

FIG. 2 is a flow diagram showing an exemplary sequence of steps to implement user-based monitoring in accordance with the present invention;

FIG. 3 is a graphical depiction of an exemplary report showing an alert condition; and

FIG. 4 is a block diagram of a system having an automated service agent to provide end-user based service monitoring.

### DETAILED DESCRIPTION OF THE INVENTION

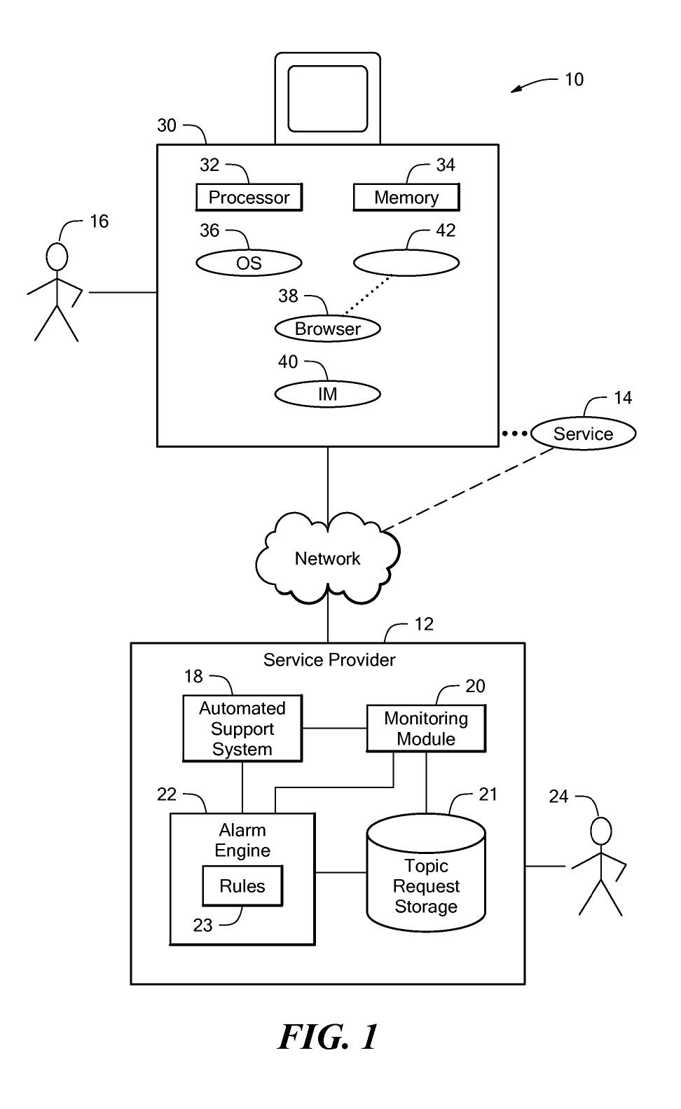

FIG. 1 shows an exemplary system 10 including a service provider 12 that provides a service 14 to end users 16 with user-based service performance monitoring in accordance with exemplary embodiments of the invention. The service 14 can be provided, for example, as phone service, utilities, e.g., electricity, gas, water etc., Internet access, alarm system, banking, insurance, investment, and the like. In general, the service 14 can be any service for which a user 16 may contact the service provider 12 to obtain some information on the service.

In an exemplary embodiment, the service provider 12 provides end users with an automated support system 18, which can locally or remotely located. The automated support system 18 provides an automated interface for users 16 to contact the service provider 12.

In another embodiment, the automated support system 18 includes an automated agent to carry on a textual, or other type of, conversation with users to provide the desired assistance. As described more fully below, the automated agent can process user queries and interact using natural language processing.

The system 10 includes a monitoring module 20 to automatically monitor variations in user requests to the support system 18. As described below, variations in user request levels for various topics can be used to identify possible disruptions by monitoring end user interaction with the automated support system. A topic request storage database 21 can be used to store information on topic requests.

The system can further includes an alarm engine 22 to generate alarms from a set of rules 23 for transmission to a designated recipient 24. In one embodiment, the alarm recipient 24 corresponds to the topic that generated the alarm, as described more fully below.

In one embodiment, the user interacts with the automated support system 18 via a workstation 30 having a processor 32 and memory 34 on which an operating system 36 runs to support client applications, such as an Internet browser application 38 and/or an instant messaging application 40, as well as other applications 42.

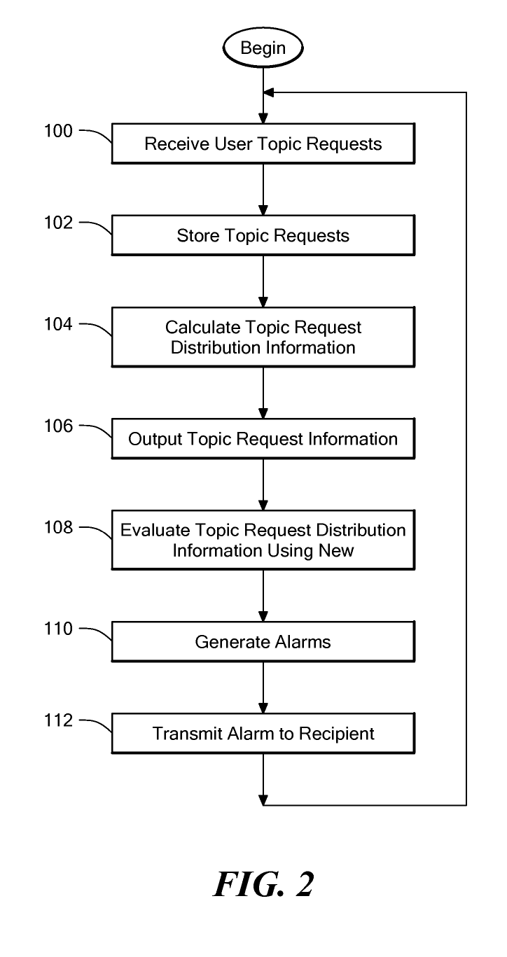

FIG. 2, in conjunction with FIG. 1, shows an exemplary sequence of steps to implement user-based monitoring in accordance with exemplary embodiments of the invention. In step 100, support requests are sent by the user and received by the automated support system. In step 102, the support requests are associated with a topic and stored. In one embodiment, various information for the support requests can be stored, such as rate (e.g., number of topic requests per unit time), length of time between topic requests, change from baseline, historical information, etc.

In step 104, the monitoring module tabulates the topic requests and calculates how they are distributed for storage of topic distribution history information. In one embodiment, a topic distribution history includes the level of customer (user) inquiries for each topic that can be used to calculate averages and moving averages of queries to each topic, over a range of operator-determined time-period settings (i.e. hourly, daily, weekly, during specific ranges of minutes, hours, days, weeks. etc.). These average user query activity levels to each topic form a base line level. In optional step 106, the monitoring module outputs the current topic distribution level, such as for a display.

In step 108, the alarm rules can be used to evaluate the current topic distribution and history to trigger alarms upon identification of predetermined criteria, such as statistically significant differences, particularly increases in user query activity level to specific topics in the current topic distribution in comparison to the baseline from the topic distribution history. In one embodiment, trends for particular topic requests are identified and alarms are generated after identifying a trend of a percentage increase above a predetermined threshold. The level of statistical significance and threshold of acceptable ranges of variance can be defined by the rules, which can be provided by an operator managing the system, for example.

If an alarm condition has occurred as defined by the rules, in step 110 one or more alarms are generated and sent to a designated alarm recipient in step 112. The alarm recipient can be an employee or contractor of the service provider company responsible for system management or other designated individual or entity.

In one embodiment, an alarm condition indicates that a specific support topic has been accessed by end users over the specified time period at a level that is above a predetermined threshold, indicating a likelihood that a component associated with the topic may have a failure, malfunction, communication issue, etc.

In general, the alarms can be transmitted via any form of suitable electronic communication, including but not limited to electronic mail, telephone text messages, telephone voice messages, and paging system messages.

The automated support system can track user requests by topic in a variety of ways. In one embodiment, the automated support system tracks what are the most common topics requested by the end users and tracks what is the frequency of user inquiries to each topic. A topic can be defined as a specific record in a knowledge base that is delivered to users' based on user queries; user queries may vary in their form, but generally seek resolution or response to the same “topic” area. For example, one user may ask “why can't I get my email?” and another might say “I'm having trouble retrieving email” but both result in a query to the same topic.

### EXAMPLE

An Internet service provider (ISP) deploys an automated service agent to enable its customers to engage in conversations with an automated customer support database. The system constantly measures the level of customer inquiry to each topic stored in the automated service agent's knowledge database. The typical level of inquiry to the topic titled “problems sending email” is, for example, 76 per hour during Monday to Friday 9:00 am to 5:00 pm Eastern Standard Time. On a Tuesday afternoon, between 2:15 pm and 2:30 pm EST the level of customer inquiries to this topic is 34 during the 15-minute period, implying a query-per-hour rate of 136 queries-per-hour to this topic, which is significantly higher than the average query-per-hour rate to this topic. In this case, at 2:30 pm EST on the Tuesday afternoon experiencing the increase in query activity to this topic, the system recognizes the statistically significant abnormal increase and sends an alert (or multiple alerts per the alert management settings determined by the system's operator) indicating to people responsible for managing the company's email systems that the customer support system has discovered a potential problem with the email sending system.

The alert system is managed by the system operator and individual topics can be assigned to send alerts to an individual assigned to the area of responsibility of that topic. So in the example cited above, an individual or group of individuals in the email management area of the ISP receive an alert about the mail sending problem users are experiencing. If the topic for which the alert is generated is related to a different system (i.e. video-on-demand problems) the topics related to the different system would be set to send alerts to the specific personnel responsible for the company's specific (i.e. video-on-demand services) systems.

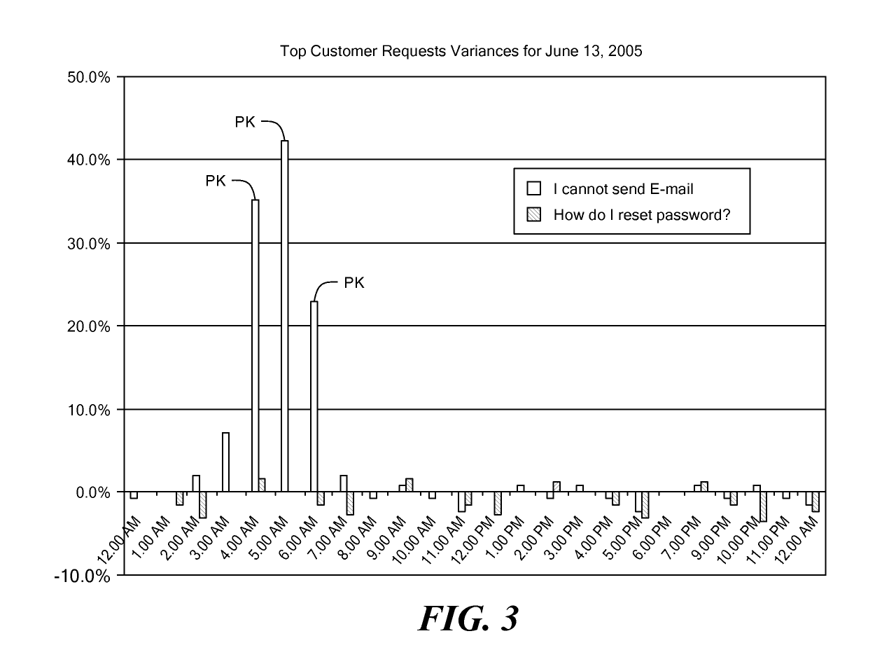

In another embodiment of the invention shown in FIG. 3, the system includes a reporting apparatus, giving companies a system overview based on the customer usage patterns to their automated support system. The reporting system graphically and numerically displays periods of high customer support inquiry rates to specific topics, revealing the period of time for which a specific system was not properly servicing customers, as evidenced by a heightened level of customer inquiries for the particular topic associated with the specific system. As shown, peaks PK at various times can indicate a flood of customer topic requests/complaints in a particular area, here shown as not being able to send E-mails. As can be seen, the series of peaks PK for the topic of ‘cannot send email’ define a trend that generates an alarm, which can be sent to the individual on call for E-mail issues. It appears that the situation was addressed as the peaks end at a short time after 6:00 am.

In another embodiment, the reporting apparatus can be configured to display on-going levels of customer inquiries to specific topics to generate a picture of the ongoing levels of health of a company's various systems deployed to customers as evidenced by the relative levels of support problems generated by customers to each service or product offering.

### EXAMPLE

Topic query rate during 10 am-11 am on average weekday are:

| | (qph-Queries Per Hour) |
|---|---|
| How Do I reset my password | 162 |
| I cannot send email | 76 |
| How do I speed up my downloads | 12 |
| How to pay my bills | 39 |
| My mailbox is full | 43 |

Topic query rate during 10 am-11 am on sampled (today) date is:

| | Qph | variance |
|---|---|---|
| How Do I reset my password | 171 | (+5.6%) |
| I cannot send email | 136 | (+74%) |
| How do I speed up my downloads | 15 | (+25%) |
| How to pay my bills | 39 | (+0%) |
| My mailbox is full | 46 | (+7%) |

In one embodiment, a statistical model of appropriate alarm events is established for each deployment, taking into consideration the degree of variance tempered with the statistical relevance. So in the above example, the large increase (+74%) in the level of query activity to the topic “I cannot send email” generates an alarm as it represents a significant (level of significance can be set by manager) and a stable sample (132/76 queries) being monitored. For example, a variance of over 50% results in the generation of an alarm. In one embodiment, the variance must be above the threshold for a given duration in order to generate the alarm.

It is understood that a wide range of techniques for establishing threshold and criteria to identify alarm events will be readily apparent to one of ordinary skill in the art without departing from the present invention.

While the alarm events are primarily shown and described in conjunction with user interaction via automated agents, it is understood that the invention is applicable to various systems and user interaction mechanisms, such as telephone call centers, menu-driven telephone messages, etc.

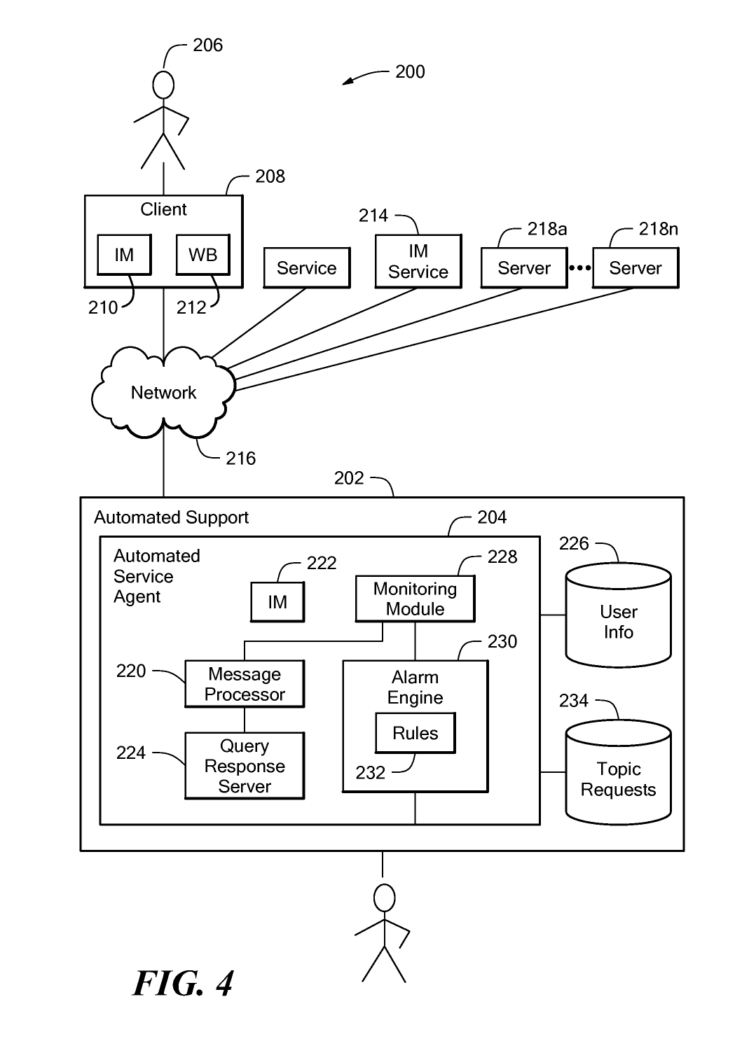

FIG. 4 shows an exemplary system 200 having an automated support system 202 that includes an automated service agent 204 to provide end-user based service monitoring. A user 206 can interact with a client workstation 208 having an IM application 210 and a web browser application 212 in a manner well known to one of ordinary skill in the art. An IM service 214 supports messaging over a network 216, such as the Internet. Various servers 218a-N support web pages that can be accessed over the network 216, which is well known to one of ordinary skill in the art.

To support IM capability, the automated support system 202 includes a message processor 220 logged into the network 216 as a user of the instant messaging service 214. The user 206 is connected to the network 216 and the IM service provider 214. The IM application 222 between message processor 220 and the network is configured to enable access to the appropriate IM service provider(s).

When the message processor 220 receives a request from the user 206, the screen name of the user is stored and, in this embodiment, the request, is forwarded to a local or remotely located query response server 224. In an exemplary embodiment, the query response server 224 includes a natural language interpreter or other intelligent system that is capable of responding to queries and other requests related to topics within at least a specified range of issues by generating an appropriate answer. The answer generated by query response server 224 is returned to the message processor 220 where it is incorporated into an output message that is subsequently sent to the user through the IM network. Alternatively, or in addition to, the output message can be forwarded to the user through any other designated means, including E-mail, fax, text messaging to wireless or hand-held devices, voice mail (via a text to speech output system), or any other type of messaging system specified by the user.

Various types of information received during the query response interaction can be stored for later use in a user profile database 226 which contain various profiles associated which each user. The profiles can be keyed to a user screen name in combination with the name of the instant messaging provider, for example “john@aol.”

The system 200 further includes a monitoring module 228, which can be similar to the monitoring module 20 of FIG. 1, an alarm engine 230 and rules 232, which can be similar to the alarm engine 22 and rules 23 of FIG. 1, and a topic request database 234, which can be similar to the topic request storage module 21 of FIG. 1.

The monitoring module 228 evaluates IM queries from users and associates the queries with a particular topic. Topic request information is stored in the database 234. Upon detecting predetermined trends in the topic requests, the alarm engine 230 generates alarms based upon the rules 232. For example, as described above, if the variance in topic requests increases more than a set amount above a baseline amount, an alarm is generated and transmitted to a designated recipient.

It will be understood by those of skill in the art that various changes and additions to the methods and systems described above can be made without departing from the spirit and scope of the invention.

What is claimed is:

1. A method, comprising:
receiving user requests for support from an automated agent of an automated support system for a plurality of topics for at least one service;
tracking the support requests for at least two of the plurality of topics;
determining trends in the tracked support requests to generate an alarm.

2. The method according to claim 1, wherein the received requests are processed by the automated agent.

3. The method according to claim 1, further including generating a baseline for topic support requests.

4. The method according to claim 1, wherein services include one or more of E-mail, Internet access, telephone, utilities, premise security, insurance coverage, banking, and investments.

5. The method according to claim 1, further including generating alarms by an alarm engine.

6. The method according to claim 1, further including identifying a party associated with the alarm and transmitting the alarm to the party.

7. The method according to claim 1, wherein determining the trend includes determining a percentage increase above a predetermined threshold.

8. The method according to claim 1, further including receiving the requests as instant messages that initiate a conversation with an automated service agent.

9. The method according to claim 1, further including updating a distribution of the support request by topic.

10. The method according to claim 9, further including comparing the distribution to a baseline distribution.

11. A system, comprising:
an automated support system to receive user requests for support for a plurality of topics for at least one service;
a monitoring module coupled to the automated support system to track the support requests and determine trends; and
an alarm module to generate an alarm based upon the trends for the topic requests.

12. The system according to claim 11, wherein the automated support system includes an automated agent to carry on a conversation with a user.

13. The system according to claim 12, wherein the automated agent communicates with the user via instant messaging.

14. The system according to claim 11, wherein the monitoring module generates a baseline for the support requests.

15. The system according to claim 11, wherein the alarm module identifies a party to receive the alarm based upon the topic that generated the alarm.

16. An article, comprising:
a storage medium having stored thereon instructions that when executed by a machine result in the following:
receiving requests for support from an automated support system for a plurality of topics for at least one service;
tracking the support requests for at least two of the plurality of topics; and
determining trends in the tracked support requests to generate alarms.

17. The article according to claim 16, wherein the automated support system includes an automated agent to process the received requests.

18. The article according to claim 16, further including instructions for generating a baseline for topic support requests.

19. The article according to claim 16, further including instructions for identifying a party associated with the alarm and transmitting the alarm to the party.

20. The article according to claim 16, further including instructions for wherein determining the trend by determining a percentage increase above a predetermined threshold.
